(19) United States
(12) Patent Application Publication
(10) Pub. No.: US 2016/0219185 A1
(43) Pub. Date: Jul. 28, 2016

(54) IMAGE PROCESSING SYSTEM, IMAGE PROCESSING APPARATUS, CONTROL METHOD, AND COMPUTER READABLE MEDIUM

(71) Applicant: CANON KABUSHIKI KAISHA, Tokyo (JP)

(72) Inventor: Takashi Tsuzuki, Yokohama-shi (JP)

(21) Appl. No.: 15/001,771

(22) Filed: Jan. 20, 2016

(30) Foreign Application Priority Data
Jan. 23, 2015 (JP) 2015-011507

(51) Int. Cl. H04N 1/333; H04N 1/00

(52) U.S. Cl. CPC H04N 1/333; H04N 1/00244; H04N 1/00307; H04N 2201/0094; H04N 2201/006

(57) ABSTRACT

An image processing system is proved in which a job received by an image processing apparatus via handover can be preferentially processed over a job received by an image processing apparatus during a time lag at the time of the handover. A job received from an information processing apparatus by a second communication unit is preferentially processed over a job received during a period since a communication with the information processing apparatus is performed by a first communication unit until a job is received from the information processing apparatus by the second communication unit.

### BACKGROUND

1. Field

Aspects of the present invention generally relate to an image processing system, an image processing apparatus, a control method, and a computer readable medium.

2. Description of the Related Art

In recent years, a so-called handover technology is utilized in a communication between an information processing apparatus and an image processing apparatus. According to the handover technology, after pairing is performed by using a near field communication method, the communication is switched to a communication based on another communication method having a longer communication distance and a faster speed than those of the near field communication method.

For example, Japanese Patent Laid-Open No. 2014-50015 discloses an image processing apparatus that transmits, after pairing is performed with an information processing apparatus by using the near field communication method, a job for executing image processing to the information processing apparatus by using a long distance communication method.

However, the technology in the related art has the following problems. Since two stages of processing including the pairing by using the near field communication and the transmission and reception of the job through a high speed communication in the long communication distance are needed for the handover technology, a time lag exists between the pairing and the transmission and reception of the job. In a case where the image processing apparatus receives a job from another information processing apparatus during the time lag, this job is processed first before the job transmitted and received by using the handover technology.

### SUMMARY

Aspects of the present invention provide a communication apparatus communicable with an information processing apparatus by using a first communication method and a second communication method different from the first communication method, the communication apparatus including a first communication unit configured to perform a communication with the information processing apparatus by using the first communication method, a second communication unit configured to receive, after the communication with the information processing apparatus by the first communication unit is performed, a job from the information processing apparatus by using the second communication method, and a processing unit configured to process the received job, where the processing unit preferentially processes a job received from the information processing apparatus by the second communication unit over a job received by the communication apparatus during a period since the communication with the information processing apparatus by the first communication unit is performed until the job is received from the information processing apparatus by the second communication unit.

Further features of the present disclosure will become apparent from the following description of exemplary embodiments with reference to the attached drawings.

### BRIEF DESCRIPTION OF THE DRAWINGS

FIG. 1 illustrates an example configuration of a communication method including an image processing system according to an exemplary embodiment.

FIG. 2 illustrates an example outer appearance of an information processing apparatus according to an exemplary embodiment.

FIGS. 3A and 3B illustrate example outer appearances of an image processing apparatus according to an exemplary embodiment.

FIG. 4 illustrates example thumbnails of a mobile terminal apparatus according to an exemplary embodiment.

FIGS. 5A and 5B illustrate example configurations of the information processing apparatus and the image processing apparatus according to an exemplary embodiment.

FIG. 6 illustrates an example configuration of an NFC unit of the information processing apparatus and the image processing apparatus according to an exemplary embodiment.

FIG. 7 illustrates an example configuration of a RAM of the image processing apparatus according to an exemplary embodiment.

FIG. 8 illustrates an example configuration of an NFC memory of the image processing apparatus according to an exemplary embodiment.

FIG. 9 illustrates an example configuration of an NFC memory of the information processing apparatus according to an exemplary embodiment.

FIG. 10 is a sequence diagram in a case where the NFC unit communicates in a passive mode.

FIG. 11 is a sequence diagram in a case where the NFC unit communicates in an active mode.

FIG. 12 is a sequence diagram in a case where the information processing apparatus and the image processing apparatus communicate each other in a push-based manner.

FIG. 13 is a sequence diagram in a case where the information processing apparatus and the image processing apparatus communicate each other in a pull-based manner.

FIG. 14 is a flow chart representing processing of the information processing apparatus according to a first exemplary embodiment.

FIG. 15 is a flow chart representing the processing of the image processing apparatus according to the first exemplary embodiment.

FIG. 16 is a flow chart representing the processing of the image processing apparatus according to the first exemplary embodiment.

FIGS. 17A to 17C illustrate example screens displayed on the image processing apparatus according to the first exemplary embodiment.

FIG. 18 is a flow chart representing the processing of the image processing apparatus according to a second exemplary embodiment.

FIGS. 19A to 19F illustrate example screens displayed on the image processing apparatus according to the second exemplary embodiment.

FIG. 20 is a flow chart representing the processing of the image processing apparatus according to a third exemplary embodiment.

FIG. 21 is a flow chart representing the processing of the image processing apparatus according to the third exemplary embodiment.

FIG. 22 is a flow chart representing the processing of the image processing apparatus according to the third exemplary embodiment.

FIG. 23 illustrates example job queue management information of the image processing apparatus according to the third exemplary embodiment.

FIG. 24 is a flow chart representing the processing of the image processing apparatus according to a fourth exemplary embodiment.

### DESCRIPTION OF THE EMBODIMENTS

Hereinafter, exemplary embodiments of aspects of the present invention will be described with reference to the drawings. It should be however noted that, unless particularly specifically described, a relative arrangement of components, a display screen, and the like described in these exemplary embodiments are not intended to limit the scope of the aspects of the present invention only by those specifications.

### First Exemplary Embodiment

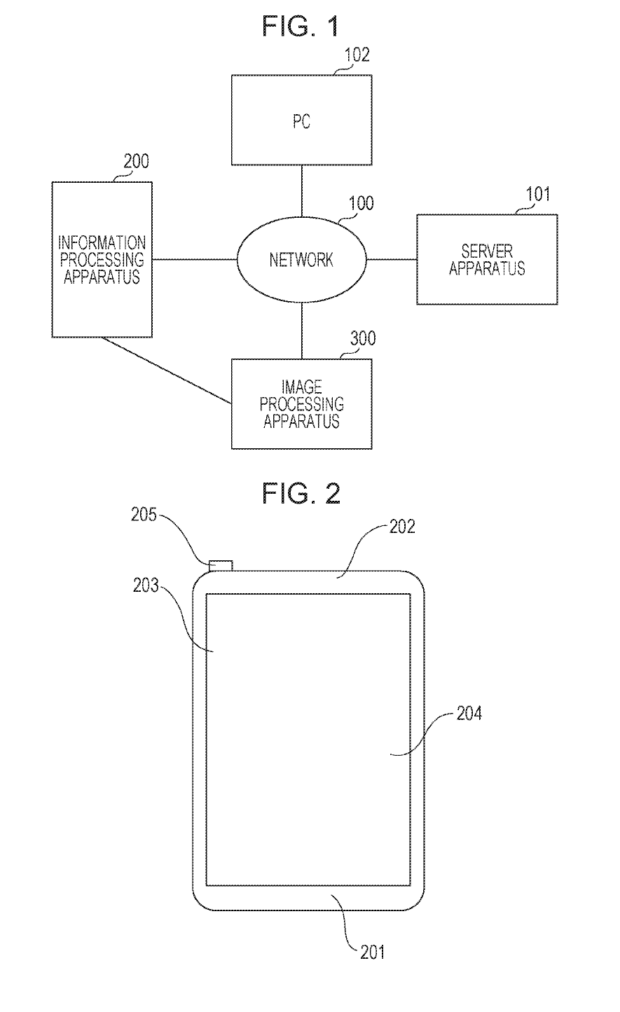

With reference to FIGS. 1 to 17, an image processing system according to the present exemplary embodiment will be described. The image processing system according to the present exemplary embodiment is constituted by an information processing apparatus and an image processing apparatus which can communicate with each other by using at least two or more types of communication methods in which authentication methods, communication speeds, and the like are different from each other. According to the present exemplary embodiment, a multi-function printer is exemplified as the image processing apparatus. It should be noted that an inkjet printer, a full-color laser printer, or a black-and-white printer can be applied as the image processing apparatus according to the present exemplary embodiment. In addition, not only the printer but also the other image processing apparatuses such as a copier and a facsimile apparatus can also be applied as the image processing apparatus. According to the present exemplary embodiment, a smart phone is exemplified as the information processing apparatus. It should be noted that various apparatuses such as a mobile terminal, a smart phone, a notebook personal computer (PC), a tablet terminal, a personal digital assistant (PDA), and a digital camera can be applied as the information processing apparatus according to the present exemplary embodiment.

According to the present exemplary embodiment, an example will be described in which, after the pairing is performed by using the near field communication method, the communication is switched to the high speed communication method to perform transmission and reception of the job. Specifically, an example will be described in which, after the pairing is performed by using the near field communication method as predefined in Near Field Communication (NFC); ISO/IEC IS 18092, the communication is switched to the high speed communication method such as WLAN.

First, a configuration of the communication method including the image processing system according to the present exemplary embodiment will be described with reference to the block diagram of FIG. 1. According to the present exemplary embodiment, descriptions will be given while the following configuration is used as an example. The present exemplary embodiment can be applied to the image processing system in which the image processing apparatus and the information processing apparatus can communicate with each other and is not intended to limit the functions as illustrated in FIG. 1.

In the communication method including the image processing system according to the present exemplary embodiment, a server apparatus 101, a personal computer (hereinafter, will be referred to as a PC) 102, an information processing apparatus 200, and an image processing apparatus 300 are connected to one another via a network 100.

The server apparatus 101 is constituted by a storage of image data for printing, user ID management, image processing application, or the like. The PC 102 is constituted by application for creating a document, a table, or the like, a printer driver configured to operate the image processing apparatus 300, or the like. The server apparatus 101, the PC 102, the information processing apparatus 200, and the image processing apparatus 300 are all connected to the network 100 via a wired LAN or a wireless LAN (hereinafter, will be referred to as a WLAN). It should be noted that, since both the information processing apparatus 200 and the image processing apparatus 300 have the WLAN function, a peer-to-peer (hereinafter, will be referred to as P2P) communication can be performed by conducting mutual authentications. It should be noted that the communication between the apparatuses may be performed via the P2P or may be performed via an access point arranged on a wired network. In addition, the communication between the apparatuses is performed, for example, by using a communication method such as Wireless Fidelity (Wi-Fi), Bluetooth (registered trademark), or NFC.

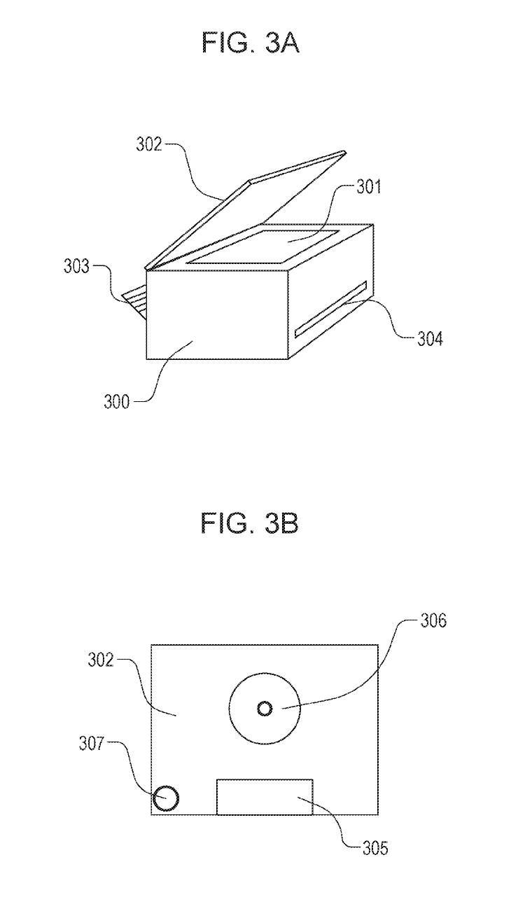

FIG. 2 illustrates an outer appearance of the information processing apparatus 200. As described above, according to the present exemplary embodiment, the smart phone is used as the information processing apparatus 200 as an example. The smart phone refers to a multi-function mobile phone provided with not only a mobile phone function but also a camera, an internet browser, an e-mail function, and the like. An NFC unit 201 is a part where the NFC communication is performed. The information processing apparatus 200 can communication with the other apparatus by presenting the NFC unit 201 to the NFC unit of the another apparatus at a distance of approximately 10 cm or closer. A WLAN unit 202 is configured to perform the WLAN communication and is arranged in the information processing apparatus 200. A display unit 203 is a display provided with a display mechanism such as an LCD system. An operation unit 204 is provided with an operation mechanism such as a touch panel system and is configured to detect press information by a user. When the user operates the operation unit 204 and presses a button displayed by the display unit 203, the information processing apparatus 200 issues an event corresponding to the pressed button. A power supply key 205 is used for turning on or off a power supply of the information processing apparatus 200.

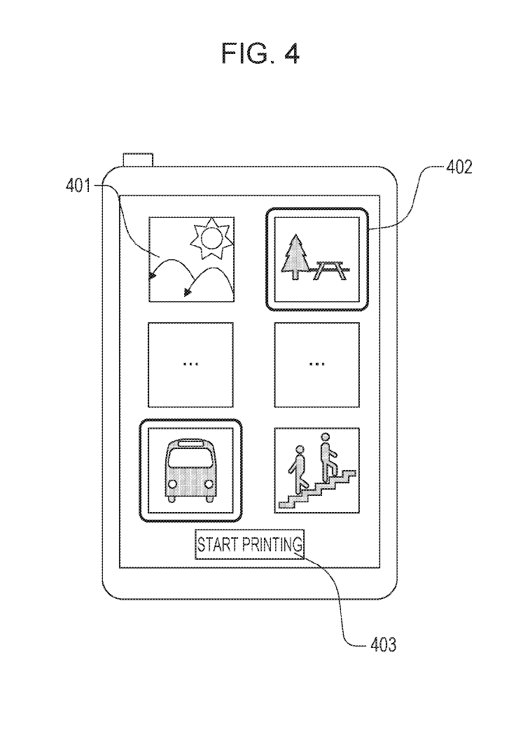

FIGS. 3A and 3B illustrate an external appearance of the image processing apparatus 300. A platen glass 301 is a transparent table made of glass and is used for placing an original document to be read by a scanner. An original document cover 302 is used such that reading light is not leaked to an external part when the scanner performs the reading. A print sheet insertion slot 303 is an insertion slot for setting sheets having various sizes. Each sheet of the sheets set here is conveyed to a printing unit that is not illustrated in the drawing and subjected to appropriate printing to be discharged from a print sheet discharging port 304. An operation display unit 305 and an NFC unit 306 are arranged on an upper part of the original document cover 302. The operation display unit 305 is provided with a display screen for displaying an image, an operation menu, or the like, an arrow key used for moving a cursor on the display unit or the like, a key for executing the other various functions, and the like. The NFC unit 306 is a part where the NFC communication is performed, and it is possible to perform the communication with the other apparatus by presenting the NFC unit 306 to the NFC unit of the another apparatus at a distance of approximately 10 cm or closer. A WLAN antenna 307 is an antenna for performing the WLAN communication.

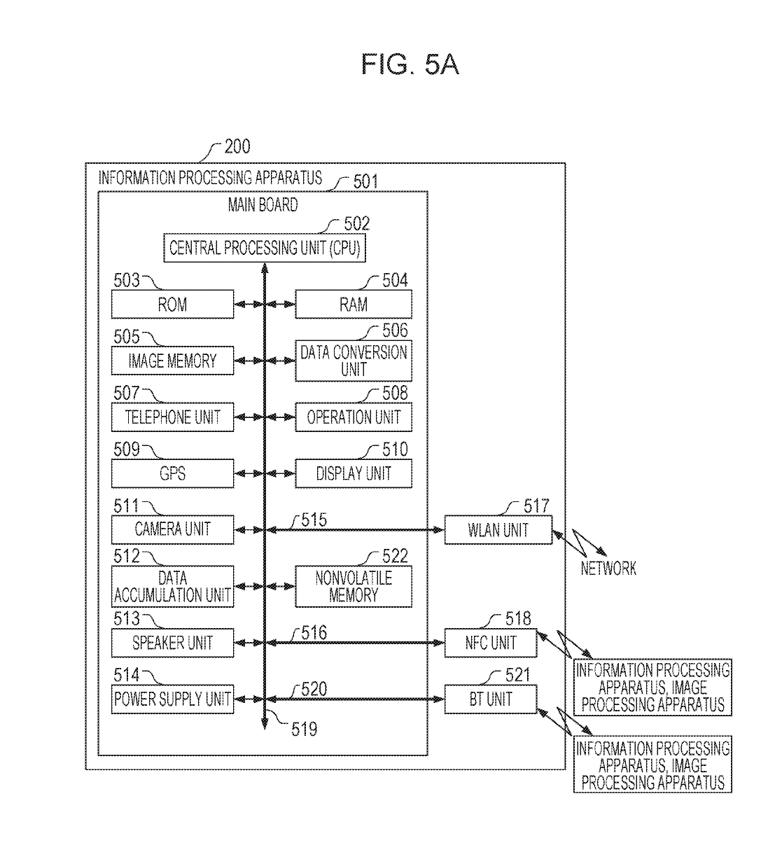

FIG. 4 illustrates an example in which thumbnails of a print candidate file are displayed on the information processing apparatus 200. Thumbnails 401 includes a thumbnail of a file saved in the information processing apparatus 200, a thumbnail of a file saved in the server apparatus 101, and the like. When the user presses the image wished to be printed, a focus 402 is displayed on the display unit 203, and it is indicated that the image is set as a printing target. Since the user can select a plurality of images as the printing targets, the plurality of focuses 402 may exist on the display unit 203. In a case where all of the thumbnails are not displayed on the single screen, a configuration may be adopted in which the user scrolls the screen to display the thumbnails that have been hidden from the screen. When the selection of the image of the printing target is ended, the user presses a printing start key 403 to transmit a print job to the image processing apparatus 300. It should be noted that the print job including the image of the printing target may be transmitted by presenting the terminal apparatus to be closer to the NFC unit of the image processing apparatus in a state in which the image of the printing target is selected instead of the press of the printing start key 403.

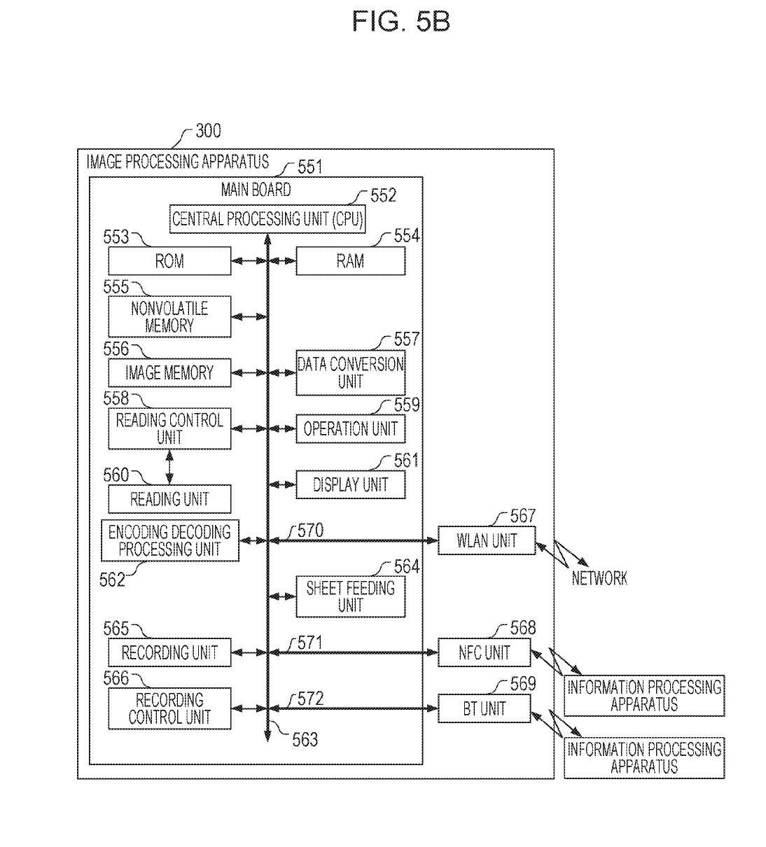

FIG. 5A is a block diagram of a configuration of the information processing apparatus 200. The information processing apparatus 200 is provided with a main board 501 that performs a main control of the apparatus, a WLAN unit 517 that performs the WLAN communication, an NFC unit 518 that performs the NFC communication, and a BT unit 521 that performs a communication based on Bluetooth (registered trademark).

In the main board 501, a CPU 502 is a system control unit and controls the entirety of the information processing apparatus 200. A ROM 503 stores control programs executed by the CPU 502, an embedded operating system (hereinafter, will be referred to as an OS) program, and the like. According to the present exemplary embodiment, software controls such as scheduling and task switching are performed under the management of the embedded OS stored in the ROM 503 in accordance with the respective control programs stored in the ROM 503. It should be noted that respective steps of a flow chart executed by the information processing apparatus of the present specification are realized while the CPU 502 reads out a program related to the flow chart from the memory and executes the program.

A RAM 504 is constituted by a static RAM (SRAM) or the like. The RAM 504 stores program control variables, set values registered by the user, management data of the information processing apparatus 200, and the like, and is provided with buffer areas for various works.

An image memory 505 is constituted by a dynamic RAM (DRAM) or the like and temporarily stores image data received via a communication unit and image data read out from a data accumulation unit 512 to be processed in the CPU 502. A nonvolatile memory 522 is constituted by a flash memory or the like and stores data wished to be saved even after the power supply is turned off. Specifically, for example, the nonvolatile memory 522 stores address book data, information concerning devices connected in past times, and the like. It should be noted that the memory configuration of the information processing apparatus 200 according to the present exemplary embodiment is not limited to this. For example, the image memory 505 and the RAM 504 may be commonly used, and data backup or the like may be performed in the data accumulation unit 512. In addition, the image memory 505 according to the present exemplary embodiment is constituted by the DRAM or the like but is not limited to this. The image memory 505 may be constituted by a hard disc, a nonvolatile memory, or the like.

A data conversion unit 506 performs an analysis of a page-description language (PDL) or the like and a data conversion such as a color conversion or an image conversion. A telephone unit 507 performs a control of a telephone circuit and can establish a communication by way of telephone while audio data input and output via a speaker unit 513 is processed. An operation unit 508 controls signals of the operation unit 204 described with reference to FIG. 2. A global positioning system (GPS) 509 obtains a latitude, a longitude, and the like at which the information processing apparatus 200 is located. A display unit 510 electronically controls a display content of the display unit 203 described with reference to FIG. 2 and performs display of various input operations, operation states of the image processing apparatus 300, status situations, and the like.

A camera unit 511 has a function of electronically recording and encoding an image input via a lens. The image shot by the camera unit 511 is saved in the data accumulation unit 512. The speaker unit 513 has a function of inputting or outputting audio for the telephone function and other functions such as an alarm notification. A power supply unit 514 includes a battery and performs a control thereof. It should be noted that states into which the power supply unit 514 may be put include a no battery state in which the battery does not have remaining power, a power supply off state in which the power supply key 205 is not pressed, an activation state in which the device is normally activated, a power saving state in which the device is activated in a power saving manner, and the like.

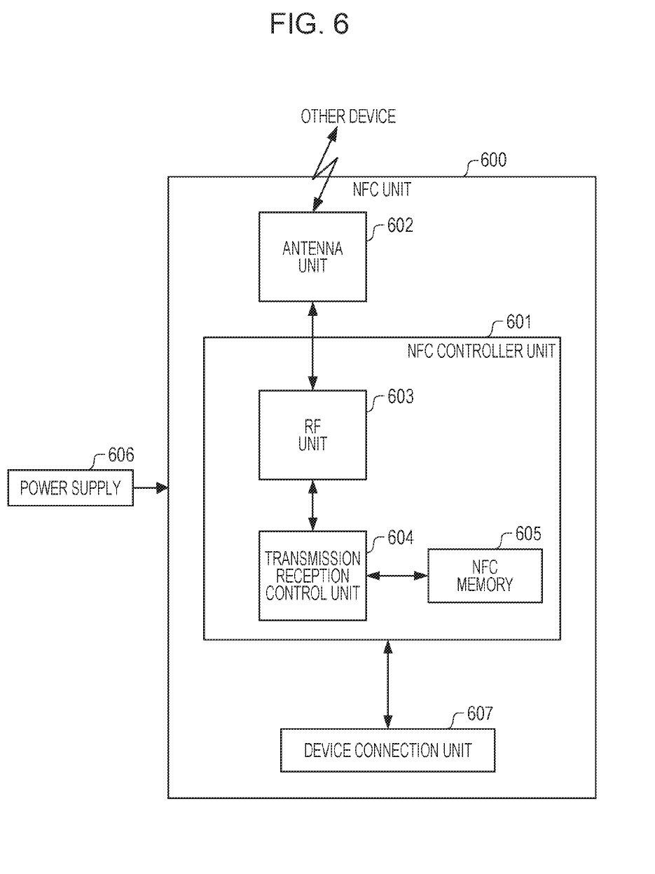

The information processing apparatus according to the present exemplary embodiment 200 is provided with a communication unit that can perform a data communication with another device such as the image processing apparatus 300 by using three wireless communication methods including WLAN, NFC, and Bluetooth (registered trademark). The above-described communication unit is constituted by the WLAN unit 517, the NFC unit 518, and the BT unit 521 which respectively realize the communications in conformity to the corresponding standards. The above-described communication unit transmits data converted into a packet to the other device and converts a packet received from the other device into data to be transmitted to the CPU 502. The data to be transmitted includes data of the job executed by the image processing apparatus 300 and the like. It should be noted that the WLAN unit 517, the NFC unit 518, and the BT unit 521 constituting the above-described communication unit are connected to one another via a bus cable or the like. The WLAN unit 517, the NFC unit 518, and the BT unit 521 are units respectively configured to realize the communications in conformity to the corresponding standards. A detail of the NFC unit will be described below with reference to FIG. 6.

It should be noted that the above-described components of the information processing apparatus according to the present exemplary embodiment 200 are connected to one another via a system bus 519 managed by the CPU 502.

FIG. 5B is a block diagram of the image processing apparatus according to the present exemplary embodiment 300. The image processing apparatus 300 is provided with a main board 551 that performs a main control of the apparatus, a WLAN unit 567 that performs the WLAN communication, an NFC unit 568 that performs the NFC communication, a BT unit 569 that performs the Bluetooth (registered trademark) communication, and the like.

In the main board 551, a CPU 552 is a system control unit and controls the entirety of the image processing apparatus 300. A ROM 553 stores control programs executed by the CPU 552, an embedded OS program, and the like. According to the present exemplary embodiment, software controls such as scheduling and task switching are performed under the management of the embedded OS stored in the ROM 553 in accordance with the respective control programs stored in the ROM 553. It should be noted that respective steps of a flow chart executed by the image processing apparatus of the present specification are realized while the CPU 552 reads out a program related to the flow chart from the memory and executes the program.

A RAM 554 is constituted by an SRAM or the like. The RAM 554 stores program control variables, set values registered by the user, management data of the image processing apparatus 300, and the like, and is provided with buffer areas for various works. A nonvolatile memory 555 is constituted by a flash memory or the like and stores data wished to be saved even after the power supply is turned off. Specifically, for example, the nonvolatile memory 555 stores user data such as network information, a list of apparatuses connected in past times, setting information of the image processing apparatus 300 such as menu items like a printing mode and correction information of an inkjet print head, and the like. An image memory 556 is constituted by a DRAM or the like and accumulates image data received via the various communication units, image data processed by an encoding decoding processing unit 562, and the like. In addition, similarly as in the memory configuration of the information processing apparatus 200, the memory configuration of the image processing apparatus 300 according to the present exemplary embodiment is not limited to this. A data conversion unit 557 performs an analysis of the page-description language (PDL) or the like, a conversion from the image data to print data, and the like.

A reading unit 560 optically reads an original document by a contact image sensor (CIS). A reading control unit 558 applies various image processings such as binarization processing and halftone processing on an image signal converted into electric image data via an image processing control unit that is not illustrated in the drawing to output high-resolution image data.

An operation unit 559 and a display unit 561 represent the operation display unit 305 described with reference to FIGS. 3A and 3B.

The encoding decoding processing unit 562 performs encoding decoding processing or expansion reduction processing on the image data (such as JPEG or PNG) processed by the image processing apparatus 300.

A sheet feeding unit 564 holds printing sheets. A recording control unit 566 performs a control for performing sheet feeding at the time of the printing execution. It should be noted that a plurality of sheet feeding units 564 may be prepared to hold plural types of sheets in a single apparatus. In the above-described case, the recording control unit 566 performs a control to determine from which of the sheet feeding units 564 the sheet feeding is performed.

Furthermore, the recording control unit 566 applies various image processings such as smoothing processing, recording density correction processing, and color correction to the image data to be printed via an image processing control unit that is not illustrated in the drawing to convert this image data into high-resolution data and outputs the data to a recording unit 565. In addition, the recording control unit 566 also plays a role of periodically reading out information of a printing unit that is not illustrated in the drawing and updating information of the RAM 554. Specifically, the recording control unit 566 updates information such as an ink tack remaining amount and a print head state.

The image processing apparatus 300 includes the communication unit that can perform the data communication with the other device by the three units similarly as in the information processing apparatus 200. The functions of the above-described communication unit are equivalent to those of the communication unit of the information processing apparatus 200. The image processing apparatus 300 receives the job from the information processing apparatus 200 via these communication units.

It should be noted that the above-described components of the image processing apparatus according to the present exemplary embodiment 300 are connected to one another via a system bus 573 managed by the CPU 552.

FIG. 6 illustrates a configuration of an NFC unit. An NFC unit 600 includes an NFC controller unit 601, an antenna unit 602, an RF unit 603, a transmission reception control unit 604, an NFC memory 605, a power supply 606, a device connection unit 607, and the like. The antenna unit 602 receives an electric wave or carrier from the other NFC device and transmits an electric wave or carrier to the other NFC device. The RF unit 603 performs modulation and demodulation of an analog signal to a digital signal. The RF unit 603 is provided with a synthesizer and identifies frequencies of a band and a channel to perform controls of the band and the channel on the basis of frequency allocation data. The transmission reception control unit 604 performs controls related to transmission and reception of data. The transmission reception control unit 604 also performs a control of the NFC memory 605 and reads and writes various data and programs. Operation methods of the NFC unit 600 generally include an active mode and a passive mode. In a case where the NFC unit 600 operates in the active mode, the NFC unit 600 receives supplied power via the power supply 606 and performs a communication with the device by using the device connection unit 607. Furthermore, the NFC unit 600 communicates with the other NFC device in a range where the communication can be established by the carrier transmitted and received via the antenna unit 602. In a case where the NFC unit 600 operates in the passive mode, the carrier is received from the other NFC device via the antenna, and power is supplied from the other NFC device by electromagnetic induction. Furthermore, the NFC unit 600 transmits and receives the data by performing the communication with the other NFC device by the carrier modulation. It should be noted that, according to the present exemplary embodiment, the information processing apparatus 200 transmits the registration information or the like by using the NFC communication. Normally, the image processing apparatus registers jobs in a job queue when the jobs including image data are received and processes the jobs in order of registration of the jobs. It should be however noted that, according to the present exemplary embodiment, before the job including the image data is received, the processing based on the job needs to be reserved at the time of the NFC communication. To carry out this reservation, the registration information registered instead of the registration of the job including the image data is transmitted before the transmission of the job including the image data. The registration information includes, for example, information such as a job name and a printing setting. The registration information is newly generated which is separate from the job before the NFC communication is performed according to the present exemplary embodiment. It should be noted that the job including the image data may be generated at a timing when the setting of the printing setting information is completed by selecting the image data or may be generated after the NFC communication is performed. It should be noted that, according to the present exemplary embodiment of an aspects of the present invention, the job refers to information for causing the image processing apparatus 300 to execute processing such as printing or scanning and is constituted by the information such as the job name, the printing setting, and the image data. In addition, according to the present exemplary embodiment of an aspect of the present invention, in a case where the transmission and reception of the job is performed by way of handover, this job is transmitted and received by using the WLAN communication.

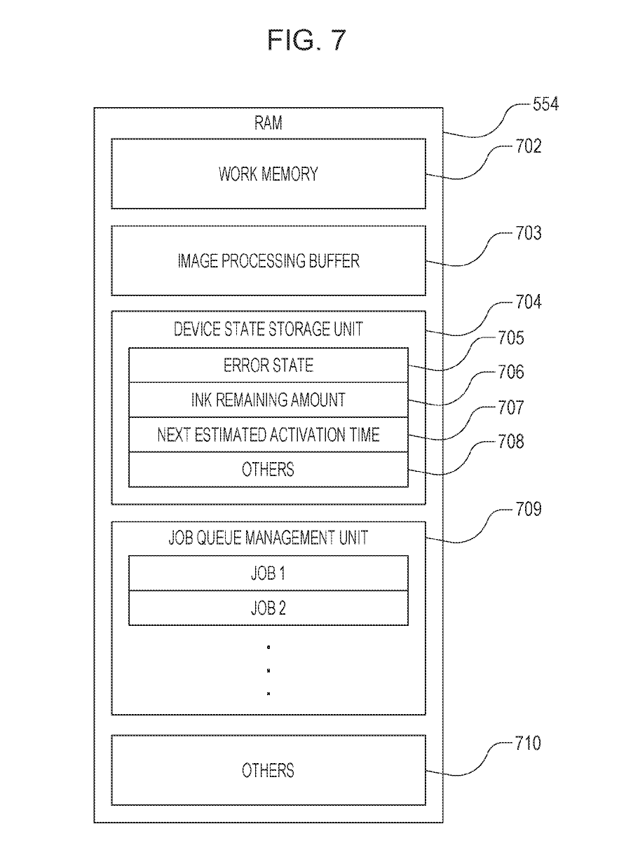

FIG. 7 illustrates a configuration of the RAM 554 of the image processing apparatus 300. A work memory 702 is a memory secured for executing the program. An image processing buffer 703 is an area used as a temporary buffer for image processing.

A device state storage unit 704 stores various pieces of information related to the current state of the image processing apparatus 300. An error state 705 stores a state related to an error of the image processing apparatus 300. The state related to the error includes an ink low state, an ink running-out state, a paper jam state, a printing sheet running-out state, a printed image defect state, a read image defect state, a network cut-off state, and the like. Degrees of influence to the printing function, degrees of influence to the reading function, and the like are associated with these states. Accordingly, for example, in the case of the ink running-out error state, the printing function is not used, but the reading function can be used. In the case of the network cut-off state, a function using the network is not used, but the setting change and reading functions that are executed by the device alone can be used. An ink remaining amount 706 stores a model of a currently attached ink tank and an ink remaining amount. The model of the ink tank is updated at a timing when the ink tank is attached to the apparatus. The ink remaining amount is updated each time the ink is used.

A next estimated activation time 707 stores an estimated activation time for the next activation when the power supply is turned off. It should be noted that the activation time of the image processing apparatus 300 largely varies depending on the power supply state. The power supply state of the image processing apparatus 300 includes, for example, a hard-off state, a soft-off state, a normal activation state, a sleep state, and the like. The hard-off state refers to a state in which power is not supplied. In a case where the power supply state of the image processing apparatus 300 is the hard-off state, the activation of the image processing apparatus 300 takes much time. In the soft-off state, power is partially supplied, but the main program is not activated. In a case where the power supply state of the image processing apparatus 300 is the soft-off state, the image processing apparatus 300 can be activated in a shorter time than the case of the hard-off state. The sleep state refers to a state in which the part involving the high power consumption is turned off, and the other program and mechanism are operated. In a case where the power supply state of the image processing apparatus 300 is the soft-off state, the image processing apparatus 300 can immediately return to the normal activation state. Another factor for the variation in the activation time of the image processing apparatus 300 includes an error state of the apparatus. For example, in a case where an error of a high degree of nozzle clogging in the inkjet print head occurs, the next activation time is lengthened since nozzle recovery processing for a long period of time is executed. In a case where an error of a decrease in the light quantity of the scanner occurs, the activation is performed after an adjustment operation is performed. In this manner, the estimated activation time for the next activation is determined on the basis of the power supply state and the error state of the apparatus. Others 708 store other states of the apparatus such as a current memory use amount, a hardware temperature, and consumable part information.

A job queue management unit 709 stores information related to the job registered in the job queue. The information includes, for example, identification information of the job which will be described below and attribute information of the job such as a sheet type, a sheet size, a printing quality, and a layout, information of a job state such as a reception waiting state, an executable state, a processing waiting state, and a processing-in-progress state, and the like. The reception waiting state refers to a state in which, after the job is registered in the job queue by using the NFC communication, the image processing apparatus waits for the reception of the job. Thereafter, in a case where the image processing apparatus receives the job by using the WLAN communication, the state of this job shifts to the executable state that will be described below. The executable state refers to a state in which the job is received, and the job can be executed. The image processing apparatus 300 processes the job in a case where this job is a job put in the executable state and also registered in a most superior position (first) of the job queue (hereinafter, will be referred to as a forefront job). The processing waiting state refers to a state in which the job is in the executable state, but the job waits for the processing because of a reason that the job is not the forefront job or the like. The job in the processing waiting state is processed by the image processing apparatus 300 when the job turns to the forefront job, and the state of the job shifts to the processing-in-progress state. The processing-in-progress state refers to a state in which the job is being processed by the image processing apparatus 300. This information is stored for each of the registered jobs, and accordingly, the order of the job registrations and the order of the processing on the jobs are also managed. Others 710 store the other RAM data.

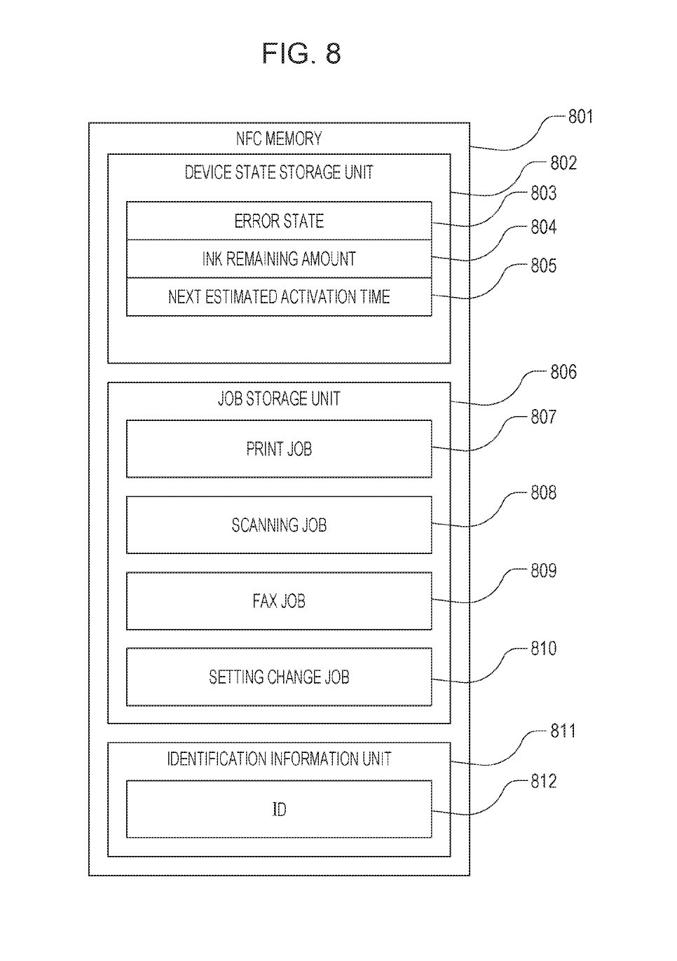

FIG. 8 illustrates a configuration of an NFC memory 801 provided in the image processing apparatus 300. A content of the device state storage unit 704 is copied in a device state storage unit 802 at a predetermined timing. A job storage unit 806 is an area used in a case where the job is input from the information processing apparatus 200 by using the communication based on NFC. In a print job 807, a print job is stored in the queue. Specifically, the print job 807 stores a printing setting and information such as a link destination to the image. In a scanning job 808, a scanning job is stored in the queue. Specifically, the scanning job 808 stores a reading setting and the like. In a FAX job 809, a FAX job is stored in the queue. Specifically, the FAX job 809 stores a FAX setting including a telephone number of a transmission destination, a communication image quality, and the like and information such as a link destination to the image. In a setting change job 810, a setting change job is stored in the queue. Specifically, the setting change job 810 stores a job related to a change in the setting of the image processing apparatus 300. An identification storage unit 811 stores identification information. The identification information is, for example, ID information. In this case, the identification storage unit 811 stores a unique ID that is not registered in the job queue management unit 709. The identification information is transmitted from the image processing apparatus 300 to the information processing apparatus 200 at the time of the NFC communication and is used for identifying the job transmitted and received by way of handover. It should be noted that the job identification is not limited to the above-described mode and may be performed by utilizing, for example, a flag or the like.

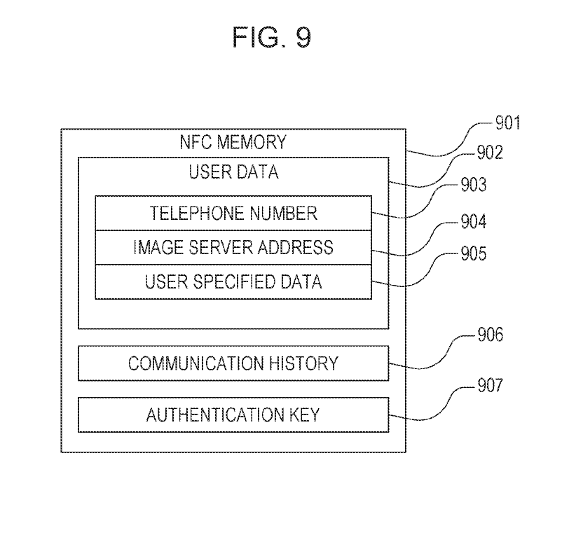

FIG. 9 illustrates a configuration of an NFC memory 901 of the information processing apparatus 200. User data 902 includes a telephone number 903, an image server address 904, and the like, and it is also possible to add user specification data 905 and the like by a specification of the user. The user data 902 also includes a communication history 906 and the like. An authentication key 907 is utilized for reading and writing of the data in the NFC memory 605. It should be noted that, when the communication is performed as the target in the passive mode even in a case where the battery remaining amount of the information processing apparatus 200 runs out, the authentication is carried out by using the authentication key 907 in a predetermined procedure, so that reading and writing of the data in the NFC memory 901 can be performed.

Next, the NFC communication will be described. In a case where a proximity communication by using the NFC units is performed, first, an apparatus that outputs a radio frequency (RF) field and starts the communication is referred to as an initiator. On the other hand, an apparatus that responds to a command issued by the initiator and performs the communication with the initiator is referred to as a target.

The communication mode of the NFC unit includes the passive mode and the active mode. In the passive mode, the target responds to the command of the initiator by performing RF load modulation. On the other hand, in the active mode, the target responds to the command of the initiator by using the RF field emitted by the target itself.

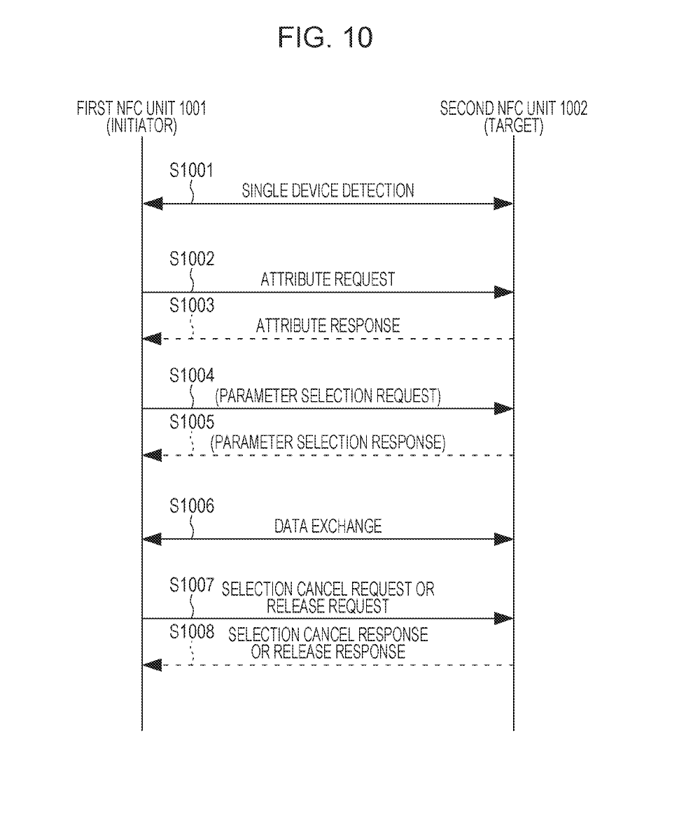

FIG. 10 illustrates a sequence in a case where the NFC unit performs data exchange in the passive mode. Herein, descriptions will be given of the case where a first NFC unit 1001 operates as the initiator, and a second NFC unit 1002 operates as the target.

First, in step S1001, the first NFC unit 1001 detects a single device to identify the second NFC unit 1002. Next, in step S1002, the first NFC unit 1001 transmits its own identifier, a bit transmission speed for the transmission and reception, an effective data length, and the like as an attribute request. The attribute request includes general byte which can be arbitrarily selected and used. In a case where the valid attribute request is received, the second NFC unit 1002 transmits an attribute response in step S1003. It should be noted that the transmission from the second NFC unit 1002 is performed by the load modulation since the NFC unit is in the passive mode. It should be noted that the data transmission based on the load modulation in the drawing of this application is represented by a dotted line arrow.

After the valid attribute response is confirmed, the first NFC unit 1001 transmits a parameter selection request in step S1004. Parameters included in the parameter selection request are the transmission speed and effective data length. In a case where the valid parameter selection request is received, the second NFC unit 1002 transmits a parameter selection response in step S1005 and changes the parameters of the transmission protocol. It should be noted that steps S1004 and S1005 may be omitted in a case where the parameter change is not performed.

Next, in step S1006, the first NFC unit 1001 and the second NFC unit 1002 perform data exchange on the basis of a data exchange request and a data exchange response. In the data exchange request and response, information with respect to application of the communication partner and the like can be transmitted as the data, and in a case where the data size is large, the data can also be divided and transmitted.

When the data exchange is ended, the flow shifts to step S1007, and the first NFC unit 1001 transmits one of a selection cancel request and a release request. In a case where the selection cancel request is transmitted, the second NFC unit 1002 transmits a selection cancel response in step S1008. When the selection cancel response is received, the first NFC unit 1001 cancels the communication with the second NFC unit 1002, and the flow returns to step S1001. In a case where the release request is transmitted, in step S1008, the second NFC unit 1002 transmits a release response and cancels the communication with the NFC unit 1001 to return to the initial state. When the first NFC unit 1001 receives the release response, since the communication with the NFC unit 1002 is cancelled, the first NFC unit 1001 may return to the initial state.

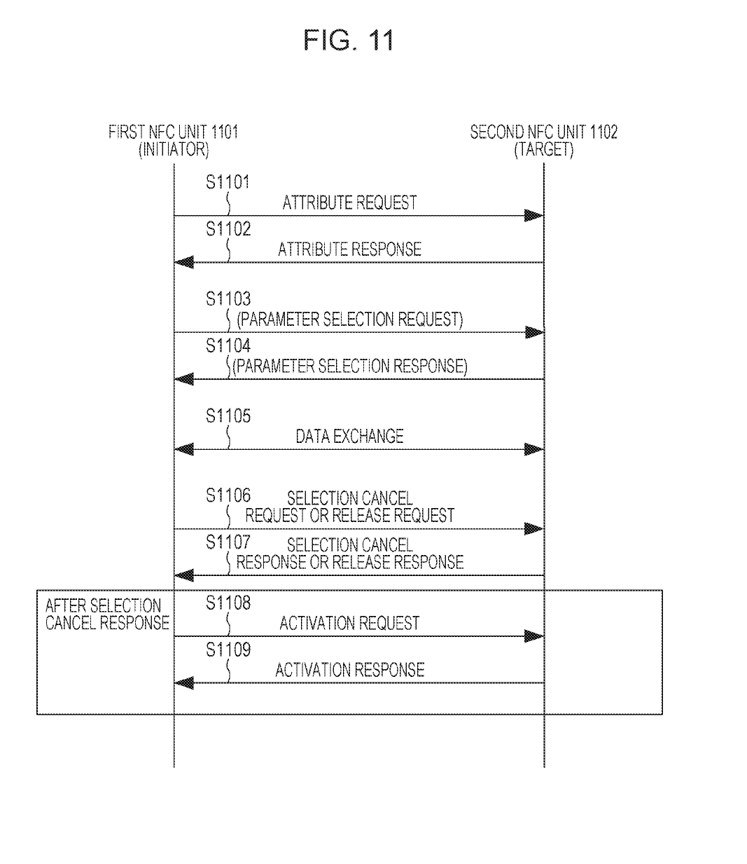

FIG. 11 illustrates a sequence in a case where the NFC unit performs the data exchange in the active mode. Herein, descriptions will be given of a case where the NFC unit 1101 operates as the initiator, and the NFC unit 1102 operates as the target.

It should be noted that, since the processing in step S1101 performed by the NFC unit 1101 corresponding to the first NFC unit and the processing in step S1102 performed by the NFC unit 1102 corresponding to the second NFC unit are similar to those in steps S1001 and S1002 of FIG. 10, detailed descriptions thereof will be omitted. Herein, the transmission from the NFC unit 1102 is performed by using the RF field emitted from itself. For this reason, when the data transmission is ended, the first and second NFC units stop the output of the RF field.

In addition, since the processing in step S1103 performed by the NFC unit 1101 and the processing in step S1104 performed by the NFC unit 1102 are similar to those in steps S1004 and S1005 of FIG. 10, detailed descriptions thereof will be omitted.

Moreover, since the processings in steps S1105 to S1107 are similar to the processings in steps S1006 to S1008 of FIG. 10, detailed descriptions thereof will be omitted. Thereafter, in step S1108, the NFC unit 1101 transmits an activation request to another NFC unit in which the identifier is already found out. The NFC unit that has received the activation request transmits an activation response in step S1109, and the flow returns to step S1101. In a case where the release request is transmitted, in step S1107, the NFC unit 1102 transmits the release response and cancels the communication with the NFC unit 1101 to return to the initial state. When the NFC unit 1101 receives the release response, since the communication with the NFC unit 1002 is cancelled, the NFC unit 1101 may return to the initial state.

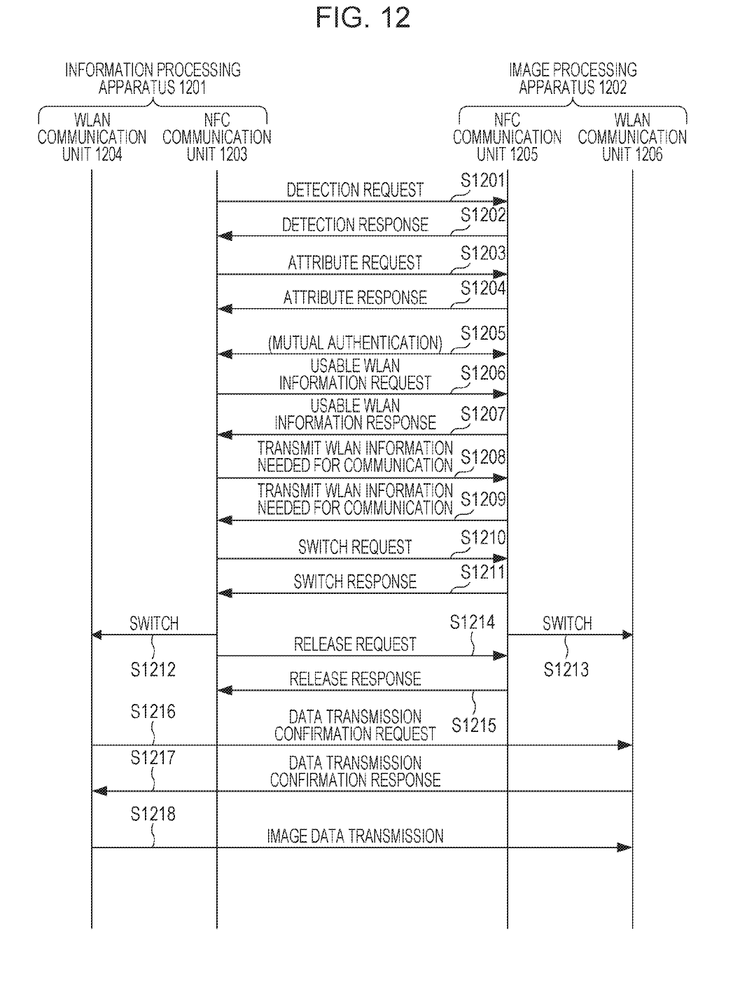

FIG. 12 illustrates a sequence in a case where transmission and reception of data are performed by way of handover. The handover is a technology with which, after the pairing for exchanging the communication information for performing the communication based on the high speed communication method is performed by using the near field communication method, the system is switched to the high speed communication method to perform the transmission and reception of the data. According to the present exemplary embodiment, the communication method based on the NFC communication is used as the near field communication method, and the communication method based on the WLAN communication is used as the high speed communication method. The communication speed of the NFC communication is several hundred bps and is a relatively low speed. For this reason, an authentication between apparatuses or the like is performed in the NFC communication, and the transfer of data having a large capacity is performed in the WLAN communication in which the communication speed is fast, so that the efficient data transfer can be realized.

FIG. 12 illustrates an example of a case in which a so-called push transfer is performed where the information processing apparatus 1201 proactively performs the transfer to print image data existing on an information processing apparatus 1201 by an image processing apparatus 1202.

In step S1201, to establish an NFC communication, an NFC communication unit 1203 operates as an initiator to detect an NFC communication unit 1205 as a target. In a case where the NFC communication unit 1205 is properly detected, in step S1202, the NFC communication unit 1205 transmits a detection response. It should be noted that, the example in the drawing illustrates a case where the information processing apparatus 1201 operates as the initiator, but in actuality, the image processing apparatus 1202 may operate as the initiator on the basis of an input from the operation display unit 305 or the like. In a case where the detection response is properly received, the NFC communication unit 1203 transmits the attribute request for performing the NFC communication in step S1203. The NFC communication unit 1205 that has received the attribute request returns the attribute response in step S1204. Herein, when the attribute request and the attribute response are issued, the respective apparatuses transmit NFC IDs of the initiator and the target and receive the corresponding IDs to identify the communication partners.

Mutual authentication between the apparatuses is performed in step S1205, so that it is possible to exchange a cryptographic key for data encryption or the like between the apparatuses. It should be noted that this mutual authentication can be avoided in a case where the cryptographic key does not need to be sent, for example. Thereafter, in step S1206, the NFC communication unit 1203 requests the NFC communication unit 1205 for information of a communication protocol that can be used by the image processing apparatus 1202. This request includes the information of the communication protocol that can be used by the information processing apparatus 1201. When this request is received, the NFC communication unit 1205 can recognize that the WLAN communication of the information processing apparatus 1201 can be utilized. In step S1207, the NFC communication unit 1205 responds and replies information of the communication protocol that can be used by itself with respect to the request received in step S1206. Accordingly, the mutual apparatuses can grasp the communication protocols that can be used by the mutual apparatuses.

Herein, it is assumed that the information processing apparatus 1201 operating as the initiator recognizes that the data transfer having the faster speed and the longer communication distance can be realized via WLAN as compared with NFC and determines that the communication between the apparatuses is switched to WLAN. It should be noted that, at this time, the determination to carry out the switching may be performed by the image processing apparatus 1202. In a case where the switching is determined, in steps S1208 and S1209, information needed to perform the communication via WLAN such as information of an address for identifying the communication partner is exchanged. Thereafter, the flow shifts to step S1210, and the NFC communication unit 1203 transmits a request to switch the communication from the NFC communication to the WLAN communication. When the switching request is received, the NFC communication unit 1205 performs a response in step S1211.

When the switching request and the response are properly performed, in step S1212, the communication unit of the information processing apparatus 1201 is switched from the NFC communication unit 1203 to a WLAN communication unit 1204. Furthermore, in step S1213, the communication unit of the image processing apparatus 1202 is switched from the NFC communication unit 1205 to a WLAN communication unit 1206. After the switching is performed, in step S1214, the NFC communication unit 1203 transmits the release request. The NFC communication unit 1205 that has received the release request transmits the release response in step S1215 and ends the NFC communication between the apparatuses.

In step S1216 and subsequent steps, the information needed to perform the WLAN communication exchanged in steps S1208 and S1209 is used to carry out the WLAN communication. First, in step S1216, the WLAN communication unit 1204 confirms with the WLAN communication unit 1206 if the data transfer can be performed. Herein, for example, information of a free space for temporarily saving an image desired to be transferred to the image processing apparatus 1202 or the like is confirmed. After the confirmation request is received, the WLAN communication unit 1206 transmits a response to the confirmation in step S1217. In a case where the proper response is obtained and it is determined that the data transfer can be performed, in step S1218, the WLAN communication unit 1204 transmits the image data existing on the information processing apparatus 1201 to the WLAN communication unit 1206. Accordingly, the data having the large capacity can be transferred by using the still faster communication protocol.

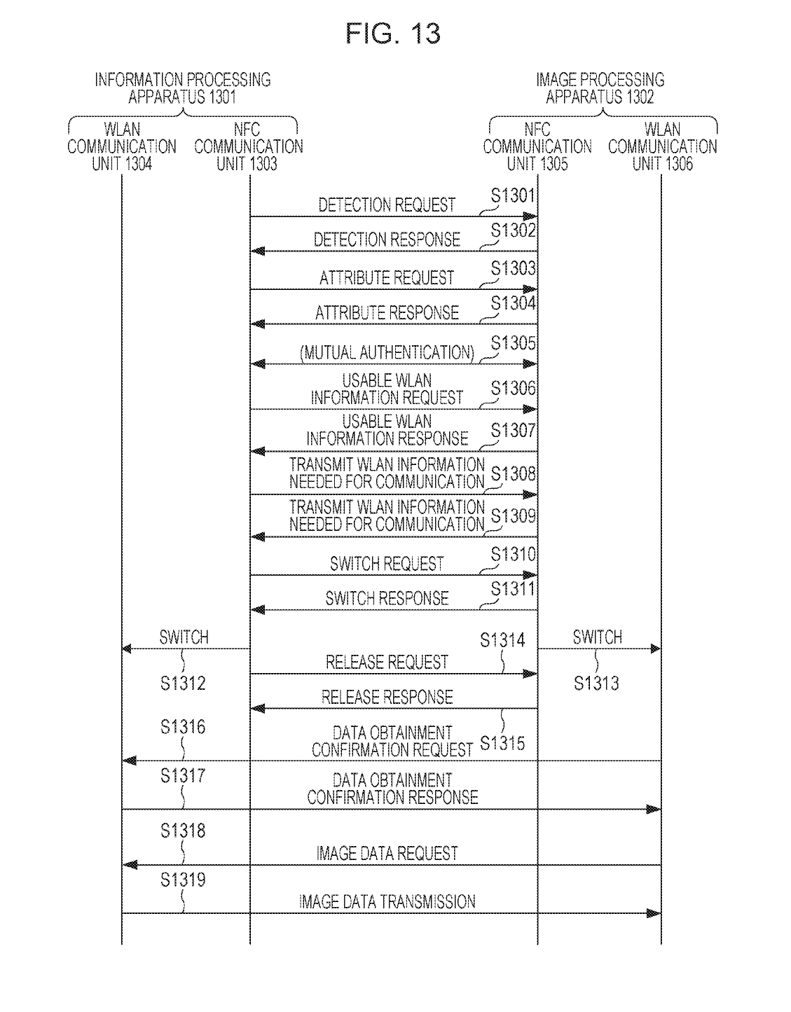

FIG. 13 illustrates an example of a case in which a so-called pull transfer is performed where the image processing apparatus 1302 proactively performs the transfer to print image data existing on an information processing apparatus 1301 by an image processing apparatus 1302. It should be noted that the processings similar to those in steps corresponding to FIG. 12 are performed in the procedure from steps S1301 to S1315, and the descriptions thereof will be omitted.

After the communication is switched from the NFC communication to the WLAN communication, first, in step S1316, a data obtainment confirmation request is transmitted from a WLAN communication unit 1306 to a WLAN communication unit 1304. Herein, for example, a size of data expected to be transferred by the information processing apparatus 1301 or the like is confirmed. After the request of the confirmation related to the transfer data is received, the WLAN communication unit 1304 transmits a response in step S1317. In a case where the WLAN communication unit 1306 obtains the proper response and it is determined that the data transfer can be performed while the free space of the printing apparatus or the like is taken into account, the WLAN communication unit 1306 requests image data in step S1318. In a case where the WLAN communication unit 1304 receives the proper request, the WLAN communication unit 1304 transmits the requested image data in step S1319.

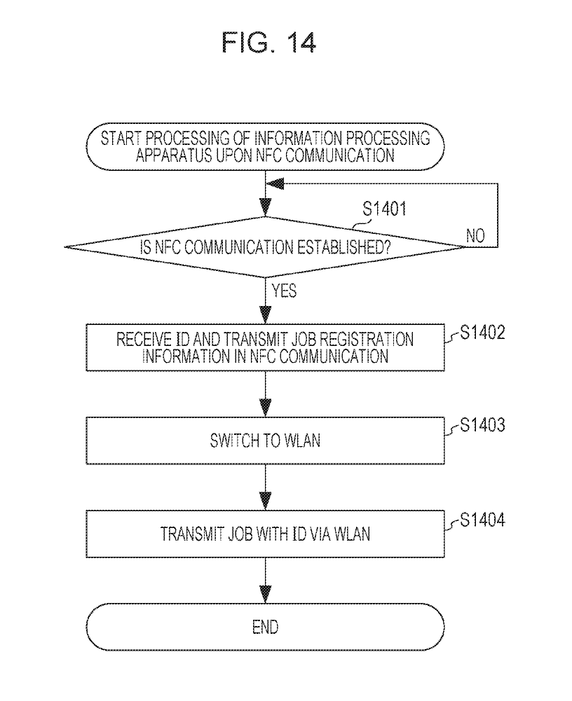

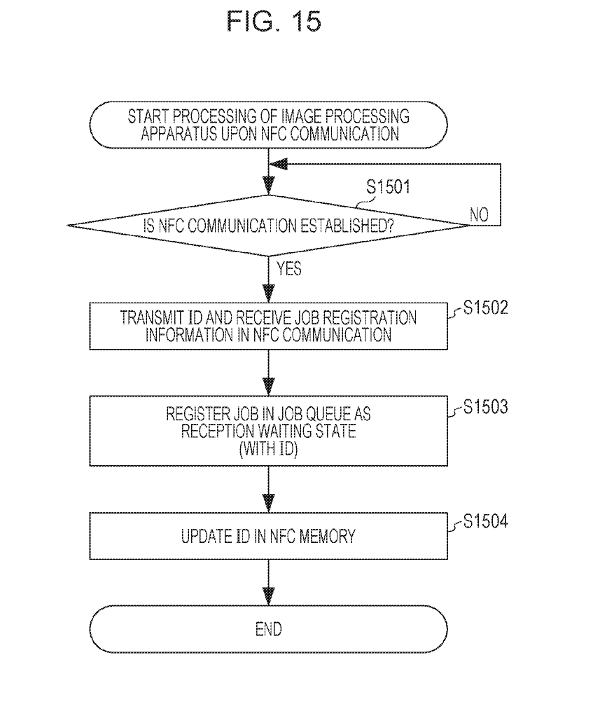

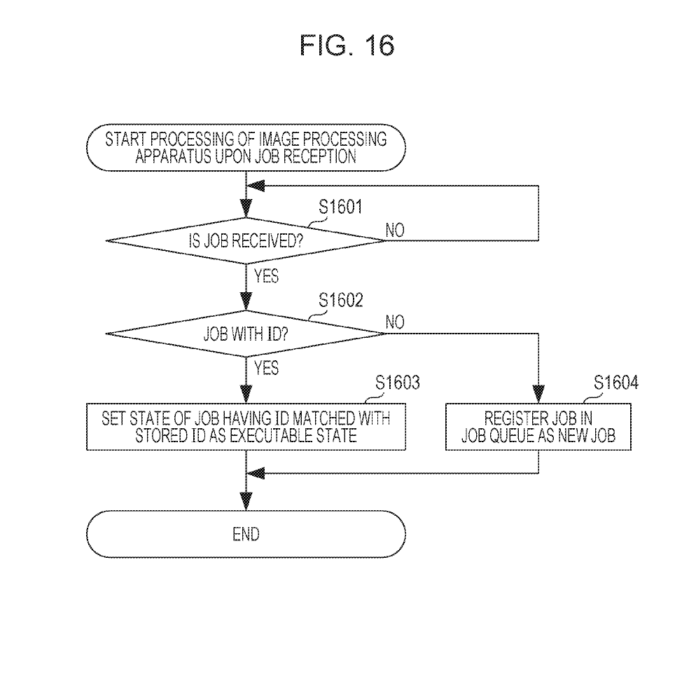

FIG. 14, FIG. 15, and FIG. 16 illustrate examples of flow charts of processing performed in the image processing system according to the present exemplary embodiment. FIG. 14 is a flow chart representing the processing of the information processing apparatus 200, and FIG. 15 and FIG. 16 are flow charts of processing of the image processing apparatus 300. It should be noted that, for descriptive purposes, a job transmitted and received by way of the handover will be hereinafter referred to as a handover job, and a job received by the image processing apparatus 300 during a time lag at the time of the handover will be hereinafter referred to as a “intra-time lag job” according to the exemplary embodiment of an aspect of the present invention.

With reference to FIG. 14, the processing performed by the information processing apparatus 200 will be described. In step S1401, the information processing apparatus 200 waits for establishment of the NFC communication. As described above, the NFC communication is established while the NFC unit 518 and the NFC unit 568 are in proximity to each other. In a case where the NFC communication is established, in step S1402, the identification information is received from the image processing apparatus 300. It should be noted that, at this time, the information processing apparatus 200 transmits the registration information of the handover job to the image processing apparatus 300. When the registration information is received, the image processing apparatus 300 registers the handover job in the job queue. The detailed flow of the NFC communication will be omitted since the flow has been described above with reference to FIG. 10 and FIG. 11. Thereafter, the information processing apparatus 200 switches the communication from the NFC communication to the WLAN communication in step S1403. When the communication is switched to the WLAN communication, the information processing apparatus 200 adds the identification information to the handover job in step S1404 and then transmits the handover job to the image processing apparatus 300.

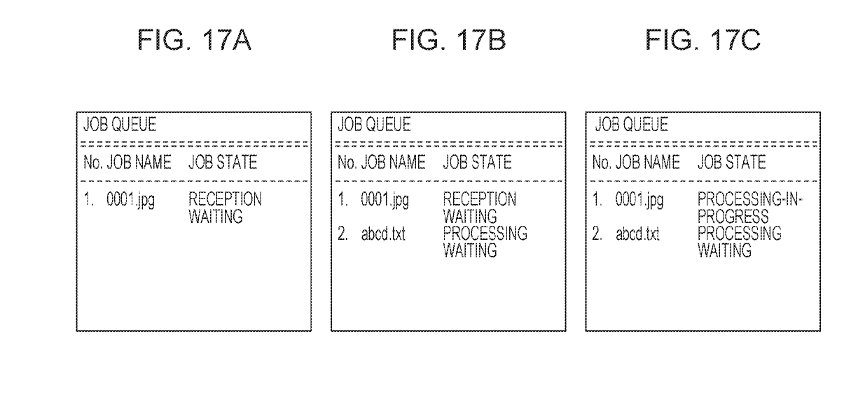

With reference to FIG. 15, the processing performed by the image processing apparatus 300 at the time of the NFC communication will be described. The image processing apparatus 300 waits for the establishment of the NFC communication in step S1501. In a case where the NFC communication is established, in step S1502, the identification information is transmitted to the information processing apparatus 200. It should be noted that, at this time, the image processing apparatus 300 receives the registration information of the handover job from the information processing apparatus 200. The detailed flow of the NFC communication will be omitted since the flow has been described above with reference to FIG. 10 and FIG. 11. When the registration information of the handover job is received, in step S1503, the image processing apparatus 300 registers the handover job in the job queue management unit 709 and puts the handover job in the reception waiting state. At this time, for example, the image processing apparatus 300 displays a screen as illustrated in FIG. 17A on the operation display unit 305, and it is indicated to the user that the handover job is in the reception waiting state. Furthermore, at this time, the identification information transmitted in step S1502 is stored in the job queue management unit 709. Thereafter, in step S1504, the identification information is changed to a unique value that is not stored in the job queue management unit 709. With the above-described configuration, when the transmission and reception of the job is performed on the basis of the handover technology next time, the same identification information as the identification information stored in the job queue management unit 709 is not transmitted to the information processing apparatus 200, and it is possible to appropriately perform the job identification. It should be noted that, in the above-described explanation, the identification information is changed in step S1504, but the configuration is not limited to this. For example, the identification information may be changed before the identification information is transmitted and received in step S1502.

With reference to FIG. 16, the processing of the image processing apparatus 300 after the registration information of the handover job is registered will be described. The image processing apparatus 300 waits for the reception of the job in step S1601. In a case where the job is received, in step S1602, it is determined whether or not the identification information is added to the received job. When it is determined that the identification information is added to the received job, it is determined that the received job is the handover job. In step S1603, the image processing apparatus 300 collates the identification information added to the job with the identification information stored in the job queue management unit 709. In a case where those pieces of the identification information are matched with each other, the image processing apparatus 300 changes the state of the handover job corresponding to the matched identification information from the reception waiting state to the executable state. With regard to the handover job put in the executable state, the processing is sequentially started in accordance with the information concerning the processing order of the jobs managed by the job queue management unit 709. It should be noted that, when the job processing is normally performed, the job queue management unit 709 cancels the registration of the job where the processing has ended. In step S1602, when it is determined that the identification information is not added to the received job, the image processing apparatus 300 determines that the received job is the intra-time lag job in step S1604. For this reason, the image processing apparatus 300 registers the received job in the job queue management unit 709 as a new job. It should be noted that, at this time, the new job is in the executable state, but since the handover job is already registered in the job queue management unit 709, the state of the new job is in the processing waiting state in which the end of the processing of the already registered job is waited for. Thereafter, in a case where the processing of the already registered job is ended and the new job turns to the forefront job, the state of the new job is shifted from the processing waiting state to the processing-in-progress state, and the processing based on the new job is started.

FIGS. 17A to 17C illustrate example screens displayed on the operation display unit 305. FIG. 17A illustrates a screen displayed on the operation display unit 305 when registration information of a job 0001.jpg corresponding to a handover job is registered in the job queue management unit 709 in step S1503. At this time, since the image processing apparatus 300 does not receive the job 0001.jpg, the state of the job 0001.jpg is in the reception waiting state. In addition, at this time, identification information corresponding to the job 0001.jpg is transmitted to the information processing apparatus 200, and the identification information is stored in the job queue management unit 709. FIG. 17B illustrates a screen displayed on the operation display unit 305 in a case where the image processing apparatus 300 receives the job abcd.txt corresponding to the intra-time lag job from the PC 102 after the display of FIG. 17A is performed. Since the identification information is not added to the job abcd.txt, the job is registered in the job queue management unit 709 as a new job in step S1604. In addition, at this time, the job abcd.txt is in the executable state but is put in the processing waiting state while the processing is not started since the job 0001.jpg exists in the superior position of the job queue. FIG. 17C illustrates a screen displayed on the operation display unit 305 in a case where the image processing apparatus 300 receives the job 0001.jpg from the information processing apparatus 200 after the display of FIG. 17B is performed. Since the identification information is added to the job 0001.jpg, the image processing apparatus 300 collates the identification information stored in the job queue management unit 709 with the identification information added to the job 0001.jpg in step S1603. Since the identification information stored in the job queue management unit 709 and the identification information added to the job 0001.jpg are matched with each other, and also the identification information is the identification information corresponding to the job 0001.jpg, the state of the job 0001.jpg shifts to the executable state. In addition, at this time, since the job 0001.jpg is the forefront job, the state of the job 0001.jpg turns to the processing-in-progress state, and the processing based on the job is performed.

With the above-described configuration, even in a case where the image processing apparatus 300 receives the intra-time lag job while the communication method between the information processing apparatus 200 and the image processing apparatus 300 is switched, the handover job can be preferentially processed. That is, it is possible to further increase the usability of the handover technology.

It should be noted that, in a case where the registration information and the handover job are received from the other information processing apparatus while the image processing apparatus 300 receives the registration information and the handover job from the information processing apparatus 200, the handover job received from the information processing apparatus 200 is preferentially processed. This is because the handover job received from the other information processing apparatus is in the executable state when the handover job is received by the image processing apparatus 300 but is put in the processing waiting state while the processing is not started since the registration information received from the information processing apparatus 200 is already registered.

### Second Exemplary Embodiment

According to the first exemplary embodiment, the example of the image processing system in which the handover job can be preferentially processed has been described. According to a second exemplary embodiment, descriptions will be further given of an example of the image processing system in which, in a case where the handover job is not received from the information processing apparatus 200 for a certain period of time or longer, it is possible to change the processing order of the jobs.

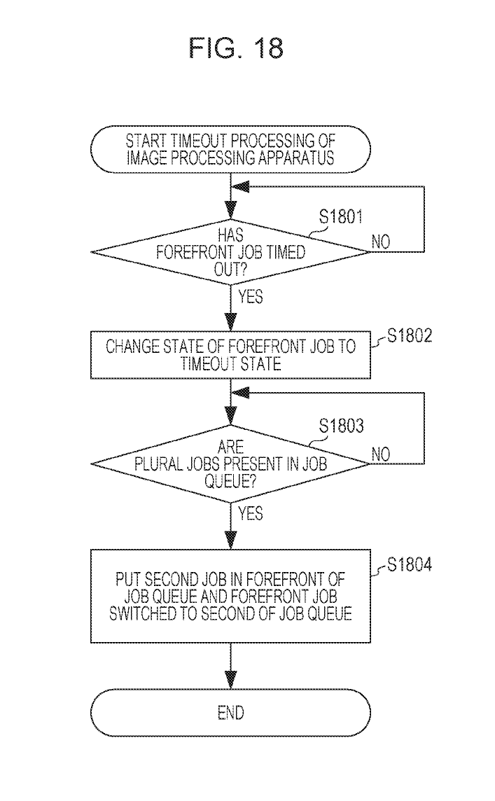

With reference to FIG. 18, timeout processing performed by the image processing apparatus 300 will be described. Timeout refers to a state in which the handover job is not received for a certain period of time (hereinafter, will be referred to as a timeout time) or longer by the image processing apparatus 300, and the timeout processing is processing performed by the image processing apparatus 300 in a case where the job has timed out. It should be noted that the timeout time may be set, for example, from the user via the operation display unit 305 as a device setting of the image processing apparatus 300 or may be set for each job. According to the present exemplary embodiment, a job queue monitoring task that is not illustrated in the drawing performs monitoring whether or not the job has timed out and the timeout processing.

The timeout processing for the job is processing performed after the registration information of the handover job is registered in the job queue management unit 709. The processing up to the registration of the handover job in the job queue management unit 709 is similar to the processing illustrated in FIG. 14 and FIG. 15, and the descriptions thereof will be omitted.

First, the job queue monitoring task monitors whether or not the forefront job has timed out in step S1801. In a case where the forefront job has timed out, the job queue monitoring task changes a state of the forefront job to a timeout state in step S1802. The timeout state refers to a state of the job in a case where the job has timed out. Thereafter, in step S1803, the job queue monitoring task determines whether or not a plurality of jobs are registered in the job queue management unit 709. In a case where the plurality of jobs are registered in the job queue management unit 709, the job queue monitoring task switches the job processing order of the forefront job that has timed out in step S1804 with that of the intra-time lag job registered in the second position of the job queue (hereinafter, will be referred to as a second job). Thereafter, the image processing apparatus 300 processes the intra-time lag job that has turned to the forefront job. After the processing based on the intra-time lag job is ended and the forefront job is changed, the job queue monitoring task performs the processing in step S1801 again.

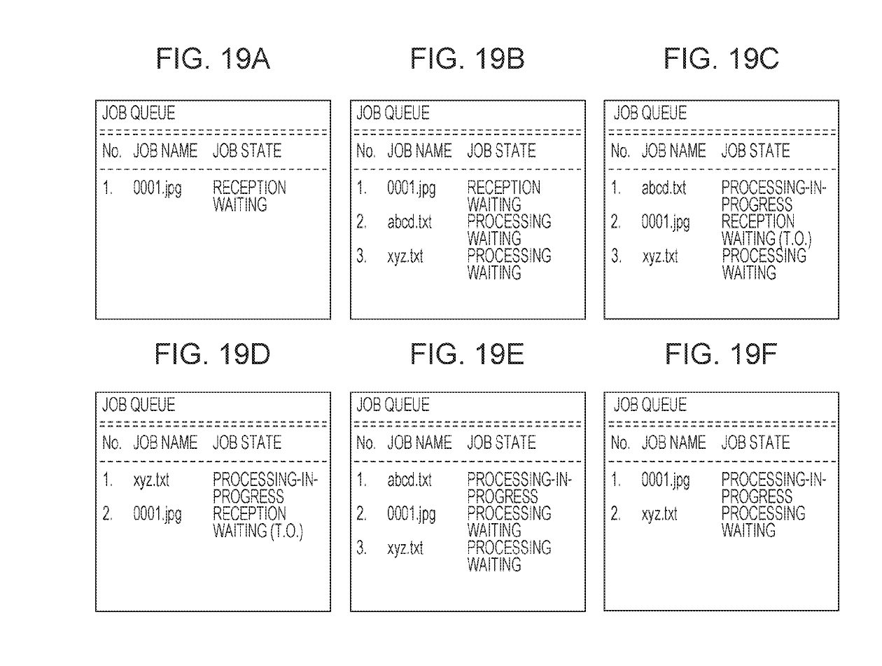

FIGS. 19A to 19F illustrate changes in the job queue displayed on the operation display unit 305 of the image processing apparatus 300 when the timeout processing is performed.

FIG. 19A illustrates a screen displayed on the operation display unit 305 in a case where the registration information of the job 0001.jpg corresponding to the handover job is registered in the job queue management unit 709 in step S1503. At this time, since the image processing apparatus 300 has not yet received the job 0001.jpg, the state of the job 0001.jpg is the reception waiting state. FIG. 19B illustrates a screen displayed on the operation display unit 305 in a case where the image processing apparatus 300 receives two intra-time lag jobs including the job abcd.txt and a job xyz.txt from the PC 102 after the display of the screen as illustrated in FIG. 19A. At this time, the job abcd.txt and the job xyz.txt are in the executable state but are put in the processing waiting state since the registration information of the job 0001.jpg is registered in the superior position of the job queue. FIG. 19C illustrates a screen displayed on the operation display unit 305 in a case where the forefront job has timed out and the processings in steps S1802 to S1804 are performed after the display of the screen as illustrated in FIG. 19B. Since the job 0001.jpg corresponding to the forefront job is put in the timeout state, the job processing order of the job 0001.jpg is switched with that of the job abcd.txt corresponding to the second job. Thereafter, since the job abcd.txt has turned to the forefront job, the state of the job is shifted from the processing waiting state to the processing-in-progress state, and the processing based on the job is performed.

Descriptions will be respectively given of a case where the image processing apparatus 300 receives the job 0001.jpg and a case where the image processing apparatus 300 does not receive the job 0001.jpg after the screen as illustrated in FIG. 19C is displayed. FIG. 19D illustrates a screen displayed on the operation display unit 305 in a case where the image processing apparatus 300 does not receive the job 0001.jpg until the processing based on the job abcd.txt that has turned to the forefront job is ended after the screen as illustrated in FIG. 19C is displayed. When the processing based on the job abcd.txt is ended, the registration of the job abcd.txt is cancelled, and the job 0001.jpg turns to the forefront job again. Thereafter, the processings from steps S1801 to S1804 are performed again, but since the job 0001.jpg corresponding to the forefront job is still in the timeout state, the job processing order of the job 0001.jpg is switched with that of the job xyz.txt corresponding to the second job. Thereafter, since the job xyz.txt turns to the forefront job, the state of the job is shifted from the processing waiting state to the processing-in-progress state, and the processing based on the job is performed. FIG. 19E illustrates a screen displayed on the operation display unit 305 in a case where the image processing apparatus 300 receives the job 0001.jpg before the processing based on the job abcd.txt is ended after the screen as illustrated in FIG. 19C is displayed. In this case, in step S1603, the timeout state of the job 0001.jpg is cancelled and turns to the executable state, but the state of the job 0001.jpg is put in the processing waiting state since the job abcd.txt is registered in the superior position of the job queue. FIG. 19F illustrates a screen displayed on the operation display unit 305 in a case where the processing based on the job abcd.txt that has turned to the forefront job is ended after the display of the screen as illustrated in FIG. 19E. When the processing based on the job abcd.txt is ended, since the job 0001.jpg turns to the forefront job, the state of the job is shifted from the processing waiting state to the processing-in-progress state, and the processing based on the job is performed.

With the above-described configuration, according to the present exemplary embodiment, even in a case where the registered handover job is not received or processed because of the connection error or the like, by switching the job registration orders in the job queue, it is possible to process the subsequent job.

### Third Exemplary Embodiment

According to a third exemplary embodiment, descriptions will be further given of an example in which the job processing order is controlled with reference to information of a function used by the handover job.

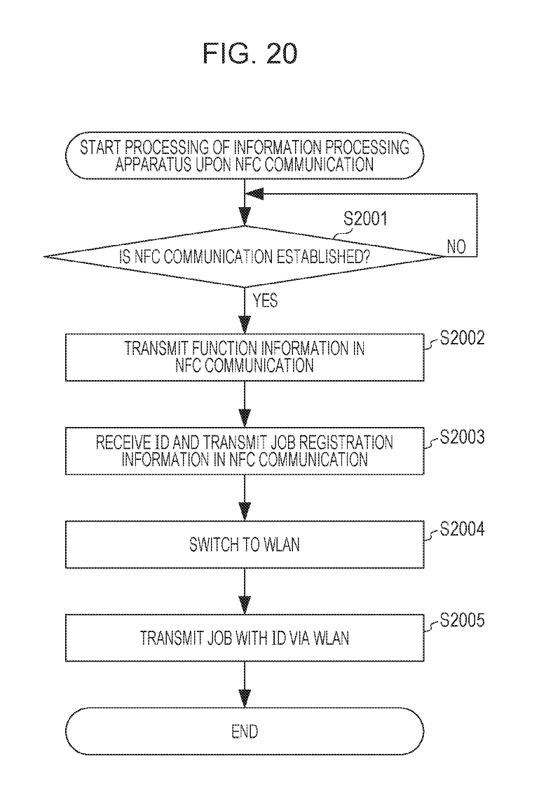

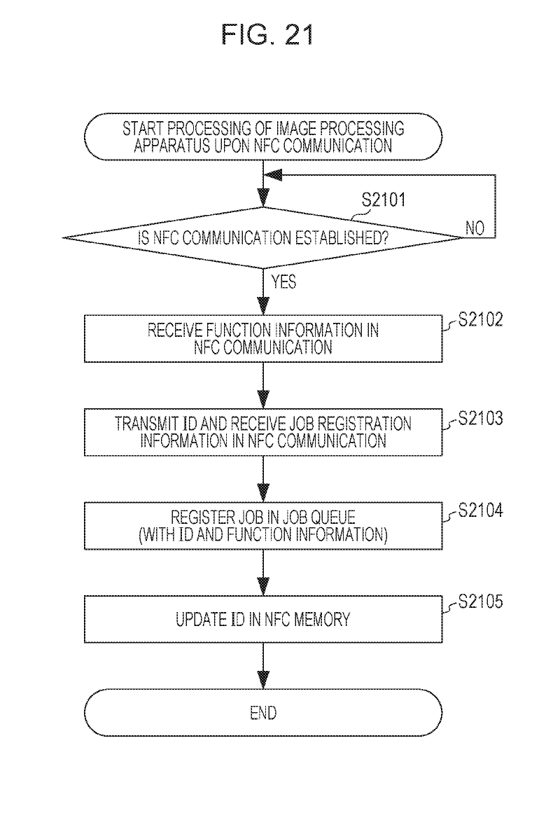

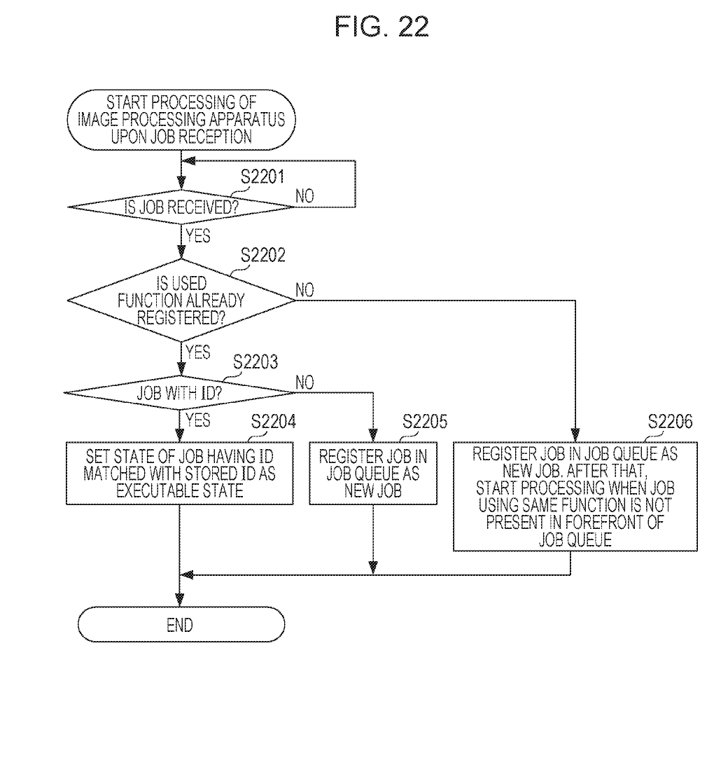

FIG. 20, FIG. 21, and FIG. 22 are examples of flow charts representing processing performed in the image processing system according to the present exemplary embodiment.

With reference to FIG. 20, processing performed by the information processing apparatus 200 will be described. The information processing apparatus 200 waits for the establishment of the NFC communication in step S2001. In a case where the NFC communication is established, in step S2002, registration information of the handover job and function information used for the processing of the handover job are transmitted. With the above-described configuration, it is possible to register the job and the function utilized for the processing based on the job in the job queue of the image processing apparatus 300. Since the processings in step S2003 and subsequent steps are similar to the processings in step S1402 and subsequent steps of FIG. 14, descriptions thereof will be omitted.

With reference to FIG. 21, processing performed by the image processing apparatus 300 at the time of the NFC communication will be described. First, the image processing apparatus 300 waits for the establishment of the NFC communication in step S2101. In a case where the NFC communication is established, in step S2102, the registration information of the handover job and the function information of the handover job are received from the information processing apparatus 200. Then, in step S2103, the identification information is transmitted to the information processing apparatus 200. Since the processings performed the image processing apparatus 300 at the time of the NFC communication are similar to the processings illustrated in the flow charts of FIG. 10 and FIG. 11, a detail thereof will be omitted. Thereafter, in step S2104, the registration information of the handover job is registered in the job queue management unit 709. At this time, the state of the handover job turns to the reception waiting state. Furthermore, at this time, the function information of the handover job received in step S2102 and the identification information transmitted in step S2103 are stored in the job queue management unit 709. Since step S2105 is similar to step S1504, descriptions thereof will be omitted.

With reference to FIG. 22, processing performed by the image processing apparatus 300 in a case where the intra-time lag job is received by the image processing apparatus 300 after the registration information of the handover job is registered will be described. In step S2201, the image processing apparatus 300 waits for the reception of the job. When the job is received, in step S2202, the image processing apparatus 300 determines whether or not the function information of the received job is the function information stored in the job queue management unit 709.

In step S2202, when it is determined that the information is not the stored function information, in step S2206, it is determined that the received job is an intra-intra-time lag job. For this reason, the image processing apparatus 300 registers the received job as a new job. In addition, since the intra-time lag job is a job that does not use the function used by the handover job, the job registration order of the intra-time lag job is switched to an order superior to that of the already registered handover job. With the above-described configuration, even when the handover job is in the reception waiting state, in a case where the intra-time lag job does not use the function used by the handover job, the processing based on the intra-time lag job is started. Thereafter, in a case where the handover job is received, since the function used by the intra-time lag job is different from the function used by the handover job, even when the intra-time lag job is being processed, the processing based on the handover job is started.

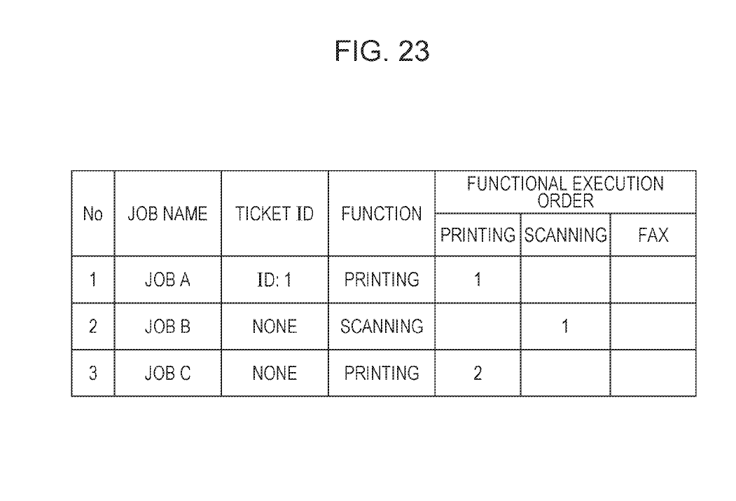

FIG. 23 illustrates an example of a table indicating information managed by the job queue management unit 709. With reference to FIG. 23, processing performed by the image processing apparatus according to the present exemplary embodiment 300 will be described. A job A is a handover job that uses the printing function from the information processing apparatus 200. A job B is an intra-intra-time lag job that uses the scanning function. A job C is an intra-intra-time lag job that uses the printing function. Herein, a case will be considered where, after the registration information of the job A is registered in the job queue management unit 709 by using the NFC communication, the image processing apparatus 300 receives the job A, the job B, or the job C.

First, a use case will be considered where the image processing apparatus 300 receives the job A. When the image processing apparatus 300 receives the job A, the image processing apparatus 300 performs the determination in step S2202. Since the job A has the function information and the identification information registered in the job queue management unit 709, it is recognized that the job A is the handover job, and the processing based on the job A is started.

Next, a use case will be considered where the image processing apparatus 300 receives the job B. When the image processing apparatus 300 receives the job B, the image processing apparatus 300 performs the determination in step S2202. Since the job B does not have the function information registered in the job queue management unit 709, the processing in step S2206 is performed. That is, the processing based on the job B is started without waiting for the processing based on the job A. Thereafter, in a case where the job A is received, even when the job B is being processed, the processing based on the job A is started.

Next, a use case will be considered where the image processing apparatus 300 receives the job C. When the image processing apparatus 300 receives the job C, the image processing apparatus 300 performs the determination in step S2202. Since the job C has the function information registered in the job queue management unit 709 but does not have the identification information, it is recognized that the job C utilizes the same function as the handover job and also recognized that the job C is not the handover job. Thereafter, the job C is registered in the job queue as a new job and is in the executable state but put in the processing waiting state since the job A exists in the superior position in the job queue while the job C waits for the end of the processing based on the job A.

In a case where the intra-time lag job utilizes a different function from that of the handover job, the processing based on the handover job is not disrupted, and the processing based on the intra-time lag job does not need to stand by. For this reason, with the above-described configuration, it is possible to execute the processing based on the intra-time lag job that utilizes the function different from that of the handover job without standing by, and the usability of the handover technology according to the first exemplary embodiment and the second exemplary embodiment can be increased. In addition, in a case where the intra-time lag job utilizes a different function from that the handover job, the image processing apparatus 300 can perform the processing based on the handover job in parallel with the processing based on the intra-time lag job. For this reason, with a configuration in which the processing based on the handover job can be started in a case where the handover job is received during the processing based on the intra-time lag job, it is possible to process the jobs using the different functions in parallel with each other. That is, with the application of the present exemplary embodiment, the usability of the image processing system according to the first exemplary embodiment and the second exemplary embodiment can be increased.

It should be noted that, according to the above-described exemplary embodiment, the orders in the job queue are switched to control the job processing order have been described, but the configuration is not limited to this. For example, according to the present exemplary embodiment, the job queue may be prepared for individual functions, and the received job may be registered in the job queue corresponding to the function used by the received job to control the job processing order. In this case, when the function used by the intra-time lag job is different from the function used by the handover job, the respective jobs are registered in different job queues. To process the forefront job in each job queue, with the above-described configuration, the image processing apparatus 300 can start the processing based on the intra-time lag job even when the handover job is in the reception waiting state. In addition, in a case where the handover job is received thereafter, since the intra-time lag job utilizes the function different from that of the handover job, the processing based on the handover job can be started even when the intra-time lag job is in the processing-in-progress state.

### Fourth Exemplary Embodiment

According to the third exemplary embodiment, descriptions will be further given of an example in which, with reference to the information of the function used by the handover job at the time of the NFC communication, the initialization of the function used by the handover job can be executed before the processing based on the handover job is performed.

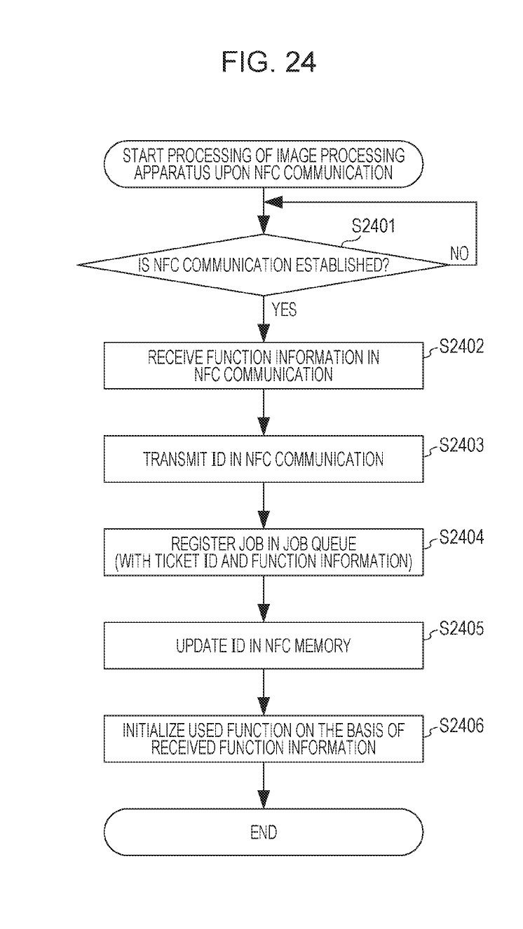

FIG. 24 illustrates an example of a flow chart representing processing performed by the image processing apparatus 300 in the image processing system according to the present exemplary embodiment after the processing illustrated in FIG. 20 is performed. Since the processings from steps S2401 to S2405 are similar to those illustrated in FIG. 21, the descriptions thereof will be omitted.

In step S2406, the image processing apparatus 300 utilizes the function information received in step S2402 to initialize the device used when the handover job is processed. The initialization of the device is processing performed by the image processing apparatus 300 to normally use the function before the function is used. For example, in a case where the function used by the handover job is a function related to the printing, the image processing apparatus 300 performs head cleaning processing, processing of releasing a cap of the ink tank, engine running processing, sheet feeding processing, and the like as the initialization of the device. Thereafter, the image processing apparatus 300 performs the processings illustrated in FIG. 16 and FIG. 22.

With the above-described configuration, since it is possible to initialize the function used by the handover intra-time lag job of the handover technology, the time used for the processing based on the handover job can be reduced.

### OTHER EXEMPLARY EMBODIMENTS

According to the above-described exemplary embodiments, the handover is performed while the communication method based on the NFC communication is used as the near field communication method, and the communication method based on the WLAN communication is used as the high speed communication method, but communication methods that realize the handover are not limited to the above. That is, the handover can be realized when two different communication methods are used. For example, communication methods such as Bluetooth (registered trademark) and TransferJet can be applied as the above-described communication methods.

The image processing apparatus according to the above-described exemplary embodiments is provided with the operation display unit 305, but aspects of the present invention can be applied to an image processing apparatus that is not provided with an operation display unit.

According to the above-described exemplary embodiments, the image processing apparatus issues the identification information and transmits the identification information to the information processing apparatus at the time of the NFC communication, but a configuration may be adopted in which the information processing apparatus issues the identification information and transmits the identification information to the image processing apparatus at the time of the NFC communication. In the above-described case, the information processing apparatus performs the processing such as the update of the ID in the memory.

According to the above-described exemplary embodiments, the registration information is set as information newly generated when the processing based on the handover job is reserved by using the NFC communication, but the configuration is not limited to this. For example, the registration information may be a part of the information of the handover job (such as the job name or the printing setting). In this case, the image of the printing target is selected, and at a timing when the setting processing of the printing setting information is completed, the handover job is generated. In the image processing system according to the exemplary embodiments of aspects of the present invention, a part of the information of the handover job and the identification information are transmitted and received by using the NFC communication, and the remaining information of the handover job to which the identification information is added (such as the image data) is transmitted and received by using the WLAN communication. In this manner, by dividing the handover job to be transmitted and received and reserving the processing based on the handover job, it is possible to reduce the amount of transmitted and received data.

According to the exemplary embodiments of aspects of the present invention, the orders of the processings in the flow charts according to the respective exemplary embodiments may be switched to one another as long as the effects of the above-described respective exemplary embodiments can be realized. In addition, all of the processings may not necessarily need to be executed, and contents of the processing may be altered. For example, a configuration may be adopted in which the order of step S2002 is switched with that of step S2003 in the processing illustrated in FIG. 20, and the function information is transmitted after the information processing apparatus 200 receives the ID.

According to the exemplary embodiments of the aspects of the present invention, the job transmitted and received by way of the handover can be more preferentially than the job received by the image processing apparatus during the time lag at the time of the handover.

Embodiment(s) of aspects of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-011507, filed Jan. 23, 2015, which is hereby incorporated by reference herein in its entirety.

What is claimed is:

1. A communication apparatus communicable with an information processing apparatus by using a first communication method and a second communication method different from the first communication method, the communication apparatus comprising:
a first communication unit configured to perform a communication with the information processing apparatus by using the first communication method;
a second communication unit configured to receive, after the communication with the information processing apparatus by the first communication unit is performed, a job from the information processing apparatus by using the second communication method; and
a processing unit configured to process the received job,
wherein the processing unit preferentially processes a job received from the information processing apparatus by the second communication unit over a job received by the communication apparatus during a period since the communication with the information processing apparatus by the first communication unit is performed until the job is received from the information processing apparatus by the second communication unit.

2. The communication apparatus according to claim 1,
wherein the first communication unit transmits identification information to the information processing apparatus by using the first communication method, and
wherein the processing unit preferentially processes a job to which the identification information is added over a job to which the identification information is not added.

3. The communication apparatus according to claim 1,
wherein, in a case where the job is not received from the information processing apparatus by the second communication unit for a predetermined time or longer after the communication with the information processing apparatus by the first communication unit is performed, the processing unit, before processing based on the job received from the information processing apparatus by the second communication unit is performed, starts processing based on the job received by the communication apparatus during the period since the communication with the information processing apparatus by the first communication unit is performed until the job is received from the information processing apparatus by the second communication unit.

4. The communication apparatus according to claim 1,
wherein, in a case where a function utilized in processing based on the job received from the information processing apparatus by the second communication unit is not utilized in processing based on the job received by the communication apparatus during the period since the communication with the information processing apparatus by the first communication unit is performed until the job is received from the information processing apparatus by the second communication unit, the processing unit, before processing based on the job received from the information processing apparatus by the second communication is performed, starts processing based on the job received by the communication apparatus during the period since the communication with the information processing apparatus by the first communication unit is performed until the job is received from the information processing apparatus by the second communication unit.

5. The communication apparatus according to claim 1,
wherein, in a case where a function utilized in processing based on the job received from the information processing apparatus by the second communication unit is not utilized in processing based on the job received by the communication apparatus during the period since the communication with the information processing apparatus by the first communication unit is performed until the job is received from the information processing apparatus by the second communication unit, the processing unit starts processing based on the job received by the communication apparatus during the period since the communication with the information processing apparatus by the first communication unit is performed until the job is received from the information processing apparatus by the second communication unit in a state in which processing based on the job received from the information processing apparatus by the second communication unit is performed.

6. The communication apparatus according to claim 1, further comprising:
an initialization unit configured to start one of head cleaning processing, processing of releasing a cap of an ink tank, engine running processing, or sheet feeding processing during the period since the communication with the information processing apparatus by the first communication unit is performed until the job is received from the information processing apparatus by the second communication unit.

7. The communication apparatus according to claim 1, further comprising:
a job queue in which jobs are registered in order of reception; and
a registration unit configured to register, in a case where registration information corresponding to the job received from the information processing apparatus by the second communication unit is received by the first communication unit from the information processing apparatus, a job that is received from the information processing apparatus by the second communication unit and corresponds to the registration information in the job queue,
wherein the processing unit processes the jobs registered in the job queue in order of registration.

8. The communication apparatus according to claim 1,
wherein the second communication method is a wireless communication method in which a communication can be performed at a speed faster than that of the first communication method.

9. The communication apparatus according to claim 1,
wherein the processing unit executes printing or scanning processing based on the received job.

10. A control method for a communication apparatus communicable with an information processing apparatus by using a first communication method and a second communication method different from the first communication method, the control method comprising:
performing a communication with the information processing apparatus by using the first communication method;
receiving, after the communication with the information processing apparatus by using the first communication method is performed, a job from the information processing apparatus by using the second communication method; and
processing the received job,
wherein a job received from the information processing apparatus by using the second communication method is preferentially processed in the processing over a job received by the communication apparatus during a period since the communication with the information processing apparatus by using the first communication method is performed until the job is received from the information processing apparatus by using the second communication method.

11. The control method according to claim 10,
wherein identification information is transmitted to the information processing apparatus by using the first communication method when performing the communication, and
wherein a job to which the identification information is added is preferentially processed over a job to which the identification information is not added.

12. The control method according to claim 10,
wherein, in a case where the job is not received from the information processing apparatus by using the second communication method for a predetermined time or longer after the communication with the information processing apparatus by using the first communication method is performed, performing processing, before performing processing based on the job received from the information processing apparatus by using the second communication method is performed, based on the job received by the communication apparatus during the period since the communication with the information processing apparatus by using the first communication method until the job is received from the information processing apparatus by using the second communication method.

13. The control method according to claim 10,
wherein, in a case where a function utilized in processing based on the job received from the information processing apparatus by using the second communication method is not utilized in processing based on the job received by the communication apparatus during the period since the communication with the information processing apparatus by using the first communication method is performed until the job is received from the information processing apparatus by using the second communication method,
performing processing based on the job received by the communication apparatus during the period since the communication with the information processing apparatus by using the first communication method until the job is received from the information processing apparatus by using the second communication method.

14. The control method according to claim 10,
wherein, in a case where a function utilized in processing based on the job received from the information processing apparatus by using the second communication method is not utilized in processing based on the job received by the communication apparatus during the period since the communication with the information processing apparatus by using the first communication method is performed until the job is received from the information processing apparatus by using the second communication method,
processing based on the job received by the communication apparatus during the period since the communication with the information processing apparatus by using the first communication method is performed until the job is received from the information processing apparatus by using the second communication method is started in a state in which processing based on the job received from the information processing apparatus by using the second communication method is performed.

15. The control method according to claim 10, further comprising:
starting one of head cleaning processing, processing of releasing a cap of an ink tank, engine running processing, or sheet feeding processing during the period since the communication with the information processing apparatus by using the first communication method is performed until the job is received from the information processing apparatus by using the second communication method.

16. The control method according to claim 10, further comprising:
registering jobs in a job queue in order of reception; and
registering, in a case where registration information corresponding to the job received from the information processing apparatus by using the second communication method is received from the information processing apparatus by using the first communication method, a job which is received from the information processing apparatus by using the second communication method and corresponds to the registration information in the job queue,
wherein the jobs registered in the job queue are processed in order of registration.

17. The control method according to claim 10,
wherein the second communication method is a wireless communication method in which a communication can be performed at a speed faster than that of the first communication method.

18. The control method according to claim 10,
wherein printing or scanning processing is executed based on the received job.

19. A non-transitory computer readable storage medium storing computer executable instructions for causing a computer to execute a control method for a communication apparatus communicable with an information processing apparatus using a first communication method and a second communication method different from the first communication method, the control method comprising:
performing a communication with the information processing apparatus busing the first communication method;
receiving, after the communication with the information processing apparatus using the first communication method is performed, a job from the information processing apparatus by using the second communication method; and
processing the received job,
wherein a job received from the information processing apparatus using the second communication method is preferentially processed in the processing over a job received by the communication apparatus during a period since the communication with the information processing apparatus using the first communication method is performed until the job is received from the information processing apparatus by using the second communication method.
